(19) United States
(12) Patent Application Publication
(10) Pub. No.: US 2013/0283152 A1
(43) Pub. Date: Oct. 24, 2013

(54) ARRANGING TEXT INTO COLUMNS

(71) Applicant: Niranjan Damera Venkata, Chennai (IN)

(72) Inventor: Niranjan Damera Venkata, Chennai (IN)

(21) Appl. No.: 13/454,701

(22) Filed: Apr. 24, 2012

(51) Int. Cl. G06F 17/24

(52) U.S. Cl. 715/244

(57) ABSTRACT

A method of arranging text into columns on a page, the text being arranged in paragraphs, includes; arranging text into a number of columns, the paragraphs comprising a number of lines having a line spacing, and adjusting the line spacing of the paragraphs such that the height of each column is substantially the same. Additionally, a method of arranging text into columns of a page, the text being arranged in paragraphs, includes; arranging text into a number of columns, the paragraphs comprising a number of lines having a line spacing, computing an option of adjusting the line spacing of the paragraphs, and adjusting the line spacing of the paragraphs according to the computed option.

### BACKGROUND

Since the first printing presses, typeset text has been organized into paragraphs placed in a number of columns on a printed page. Historically, text was organized in columns because it was easy to set the print type. Today, many forms of written and electronic publications are organized in this columnar fashion; for example, newspapers, magazines, and patents all use this organizational structure.

### BRIEF DESCRIPTION OF THE DRAWINGS

The accompanying drawings illustrate various examples of the principles described herein and are a part of the specification. The illustrated examples do not limit the scope of the claims.

FIGS. 1A and 1B are diagrams showing text arranged in columns according to examples of principles described herein.

FIG. 2 is a flowchart showing a method for arranging text in columns according to one example of principles described herein.

FIG. 3 is a flowchart showing a method for arranging text in columns according to one example of principles described herein.

FIG. 4 is a flowchart showing a method for arranging text in columns according to another example of principles described herein.

FIG. 5 is a flowchart showing a method for arranging text in columns according to another example of principles described herein.

FIG. 6 is a diagram of a computer program product, according to one example of principles described herein.

Throughout the drawings, identical reference numbers designate similar, but not necessarily identical, elements.

### DETAILED DESCRIPTION

While arranging text into columns may improve the readability and visual aesthetics of the text, there are a few characteristics that impede its effective use. For example, because a page layout restricts the amount of vertical space available within a column, arranging paragraphs within the columns may lead to columns of differing height. This misalignment of the columns creates inconsistency on the page layout. The inconsistency of the columns may counter the purpose of organizing text into columns. That is, the inconsistent columns decrease the readability of the text when the purpose of organizing text into columns is to increase the readability of the text.

Often times arranging text into columns is facilitated by a block-based text rendering system. These rendering systems do not allow a line-by-line adjustment of the text, making adjustment of the height of the column increasingly difficult.

In light of these and other issues the present specification discloses methods for arranging text into columns. According to an example, the method includes, arranging paragraphs of text into a number of columns. Arranging text into columns improves the readability of the text while enhancing the visual aesthetics of the page layout. Next, the line spacing of the paragraphs of the columns are adjusted such that the height of the columns is substantially the same. Keeping the columns relatively equal in height to one another increases the consistency of the page layout. This consistency is both visually pleasing and increases the readability of the text.

By adjusting the line spacing at the paragraph level, the method of the present disclosure may be used with a block-based text rendering system which permits the adjustment of line spacing at the paragraph level. Thus the method may be used with a wide variety of rendering systems.

The adjustments made to the line spacing may be done by deriving a closed-form mathematical equation to determine the proper line spacing of the various paragraphs of a column. A closed-form equation presents a simple, one-time calculation that may be performed to determine the appropriate line spacing. Compared to a recursive equation that requires periodic checking, and re-adjustment of the line spacing of the paragraphs, the present disclosure presents a simple, cost-efficient method to balance the textual columns.

The present specification also discloses a method for computing an option according to certain adjustment priorities, which option reflects a selected balance between line spacing and column balance. In this example, the method arranges the paragraphs of text into a number of columns. Next, using a mathematical equation, the method selects an option that reflects a selected balance between preservation of the original line spacing and column balance. The line spacing is then adjusted according to the selected option. This affords greater flexibility in arranging text into balanced columns. Thus, the present specification discloses a simple, efficient way to arrange text into balanced columns that can be used by a number of different rendering systems.

As used in this specification and in the appended claims, the term “line spacing” refers to the vertical white space between adjacent lines of text. Examples of different line spacing options include, but are not limited to double spacing, 1.5 spacing, and single spacing. In one example, the vertical white space defining the line spacing between adjacent lines of text may further be included in and help to define individual paragraphs within the text.

As used in this specification and in the appended claims, the term “block-based text rendering system” refers to a rendering system wherein adjustments to line spacing are done at the paragraph level, not on an individual text line basis. For example, the line spacing of text within a paragraph is uniformly maintained. Compare with other rendering systems where individual lines within a paragraph may have distinct line spacing. In a block-based text rendering system a paragraph that breaks across multiple columns has the same line spacing.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language refers to a particular feature, structure, or characteristic described in connection with the example is included in at least that one example, but not necessarily in other examples. The various instances of the phrase “in one example” or similar phrases in various places in the specification are not necessarily all referring to the same example.

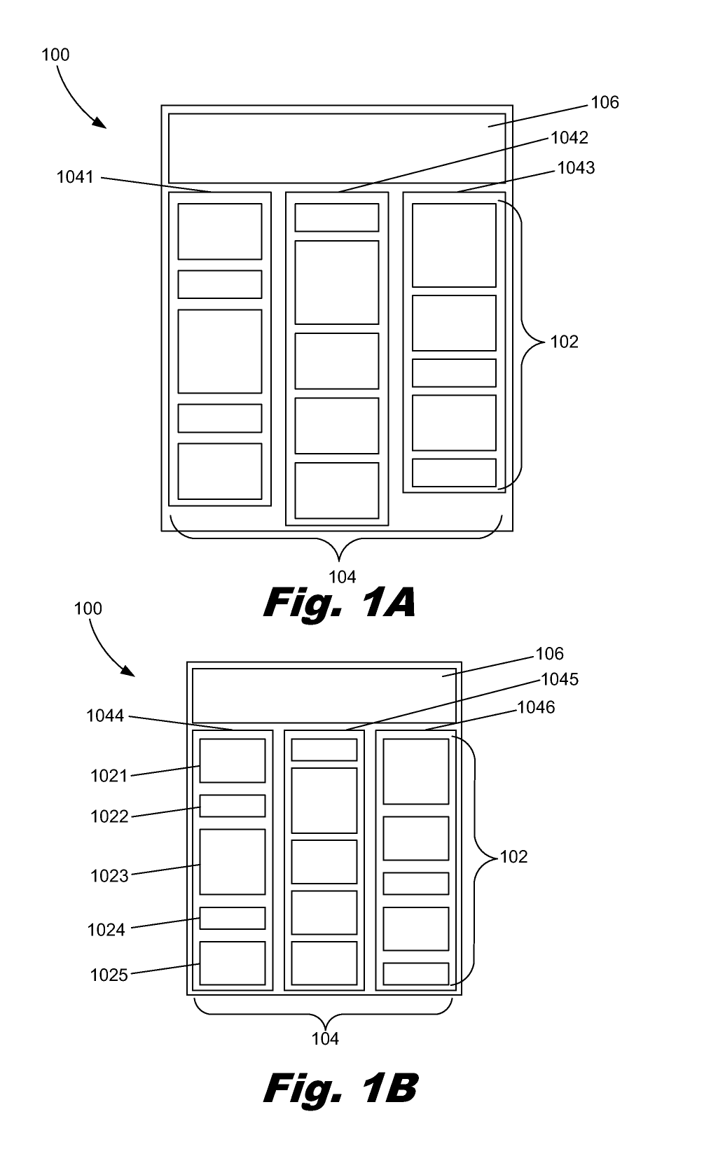

FIGS. 1A and 1B are diagrams (100) showing text arranged in columns. The diagram (100) of FIG. 1A depicts text arranged in any number of paragraphs (102). These paragraphs (102) may be further arranged into any number of columns (104). According to an example, at least one paragraph may break across multiple columns. For example, a paragraph of text may begin at the bottom of a first column (1041), and then continue onto the top of a second column (1042).

The text in each paragraph (102) may be defined by its line spacing. Line spacing refers to the vertical space present between adjacent lines of text. Line spacing is defined by a number wherein a larger value indicates more white space between adjacent lines of text. For example, a paragraph that is double-spaced has more white space between lines of text than does a single-spaced paragraph. Adjusting the line spacing of a paragraph alters the readability and visual aesthetics of a page layout.

According to an example, the line spacing of the paragraphs may be substantially the same. In this example, because text allocation to columns is discrete, the heights of the number of columns (1041, 1042, 1043) may be different. Thus the columns may be misaligned as depicted in FIG. 1A.

The diagram (100) may also include a heading (106) of text. For example, a newspaper or magazine may include a heading to present publication information relating to the newspaper or magazine.

FIG. 1B is a diagram (100) showing text arranged in columns. Similar to FIG. 1A, the diagram (100) of FIG. 1B depicts text arranged in any number of paragraphs (102). These paragraphs (102) may be further arranged into any number of columns (104). As depicted in FIG. 1B, the line spacing of the paragraphs (102) of the columns (1044, 1045, 1046) of text may be adjusted such that the column heights are substantially the same. In this example, the heights of the columns of a page are consistent throughout the page. Adjusting the line spacing at the paragraph level ensures that a paragraph that breaks across multiple columns may have uniform line spacing. According to an example, the differences in the line spacing of the columns (1044, 1045, 1046) may be imperceptible.

Adjusting the line spacing of the text to allow the columns (1044, 1045, 1046) to be consistent in height improves the visual aesthetics of the page. Moreover, the consistency of column heights may increase the readability of the text within the columns.

According to an example, the line spacing within each paragraph may be consistent, but may differ from the other paragraphs of the column. For instance, the line spacing in a first paragraph (1021) of a column (1044) may be a certain amount to allow the columns (1044, 1045, 1046) to be substantially the same height. At the same time, the line spacing of a second paragraph (1022) of the same column (1044) may be a different amount to allow the columns (1044, 1045, 1046) to be substantially the same height. In this example, the line spacing within the paragraphs (1021, 1022, 1023, 1024, 1025) is the same. Additionally, the line adjustments made to the line spacing of the first paragraph and the second paragraph may be small such as to be imperceptible to the human eye. In this example, if a paragraph breaks across multiple columns the line spacing of that paragraph may be uniformly maintained.

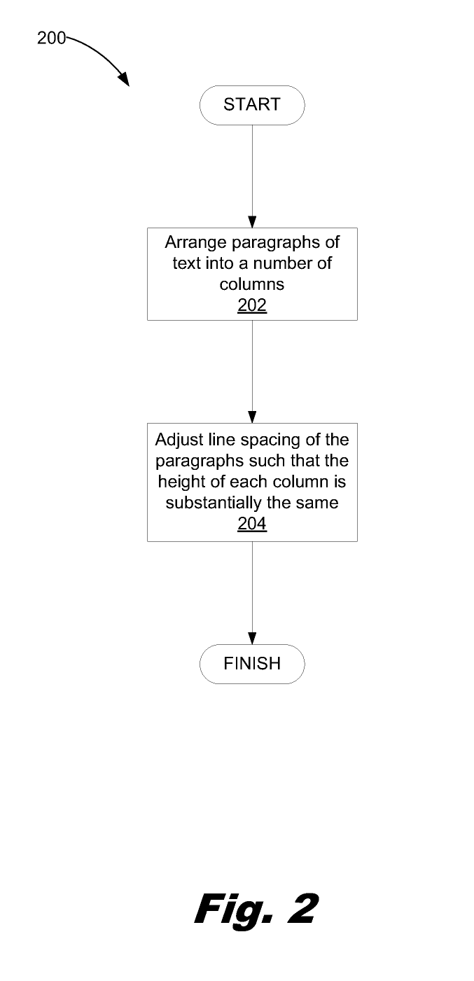

FIG. 2 is a flowchart showing a method (200) for arranging paragraphs of text in columns. The method (200) may begin by arranging (block 202) paragraphs of text into a number of columns. Examples of text organized into columns, include but are not limited to newspapers, magazines, and patents. Organizing text in columns improves the readability of the text and improves reader comprehension. Columnar text may also be more aesthetically pleasing; that is, it may be more interesting to look at from the reader's perspective.

The method (200) may also include adjusting (block 204) the line spacing of the paragraphs of text. The line spacing is adjusted so the vertical height of each column of text is substantially the same. Columns of substantially the same height are not misaligned as depicted in FIG. 1A. This aids the readability of the text and increases reader comprehension. Proper alignment of the columns also improves the visual aesthetics of the text.

According to an example, the method (200) is used in conjunction with block-based text rendering systems. A block-based text rendering system is one in which the line spacing within a paragraph is maintained. By contrast, other systems allow for line-by-line adjustments to the line spacing of text. A block-based text rendering system does not incorporate this line-by-line adjustment. When used in conjunction with a block-based text rendering system, the method (200) adjusts the line spacing of particular paragraphs of a particular column such that the line spacing within the individual paragraphs is uniform. Thus, the present disclosure presents a method (200) that allows text to be arranged into columns of substantially the same height when used with block-based text rendering systems.

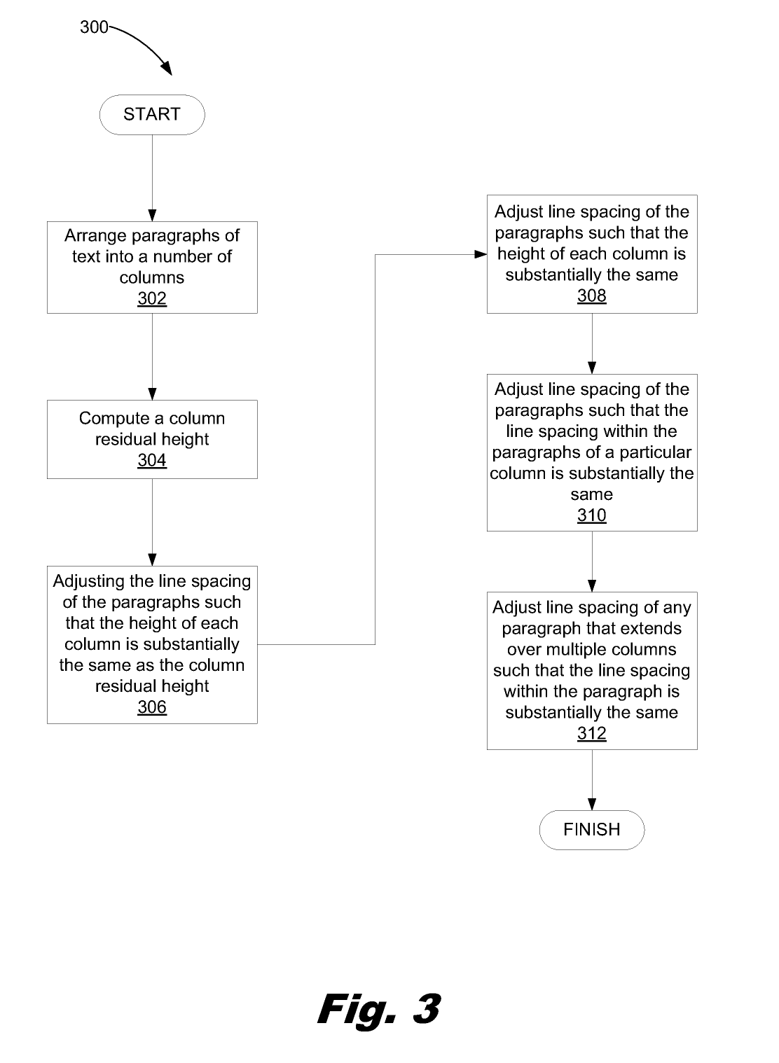

FIG. 3 is a flowchart showing a method (300) for arranging paragraphs of text into columns. The method may begin by arranging (block 302) paragraphs of text into a number of columns. Next, the method (300) may include computing (block 304) a column residual height. The column residual height is the height of the column less any fixed element within the column. An example of a fixed element may include a picture positioned within a particular column. According to one example, the column height is set and as fixed elements are placed within the column, the placement of the text is altered. The space available for text within the column is also altered. This altered amount is the column residual height.

With a column residual height computed, the method (300) may then adjust (block 306) the line spacing of the paragraphs such that the height of each column is substantially the same as the column residual height. For example, a column residual height may be six inches. The line spacing of the paragraphs that make up the columns may then be adjusted such that the height of the columns is substantially the same as six inches.

The method (300) may also adjust (block 308) the line spacing of the paragraphs such that the heights of the columns of text are substantially the same. Continuing with the example above, the columns may now be adjusted such that they are substantially the same as six inches, and also substantially the same as one another. As described above this may improve readability of the text as well as improve the visual aesthetics of the layout of the text on a page.

According to an example, the columns may be adjusted using a mathematical expression. This expression may represent a system of equations that when solved, are used to determine the appropriate line spacing of each paragraph of each column such that the columns are properly aligned to substantially the same height, and according to one example, substantially the same height as the column residual height.

An example of a mathematical expression used to adjust the line spacing of paragraphs in a column such that the height of the columns is substantially the same may be illustrated as follows:

$${Σ}_{p} {n}_{p}^{t} {l}_{p}^{f} \approx {h}_{t} ∀ l \qquad ( Eq . 1 )$$

In the above expression (Eq. 1), the letter p is an index that represents the p^{th} paragraph on a page. The letter i is an index that represents the i^{th} column on a page. The letter n represents the number of lines in a given paragraph. Thus, the term nⁱₚ refers to the number of lines in the p^{th}, in the i^{th} column. The term hᵢ refers to the column residual height. This column residual height represents the height of the column less any fixed elements within the column. These fixed elements are not adjustable within the column, thus their inclusion alters the vertical space available for text. An example of a fixed element is a picture positioned within the column. The term l′ₚ refers to the adjusted line spacing of paragraph p such that the height of the columns may be substantially the same.

Solving this equation (Eq. 1) for the adjusted line spacing of a given paragraph, l′ₚ, determines the line spacing for that paragraph that will allow the particular column to be substantially the same as the column residual height. Solving the system of equations for all paragraphs within a particular column will determine the line spacing for each paragraph in that column that will allow the particular column to be substantially the same height as the column residual height.

From this expression (Eq. 1), a closed-form equation can be derived. A closed-form equation refers to a mathematical expression whose variables can be expressed in terms of a bounded number of elementary functions. Examples of elementary functions include, but are not limited to, arithmetic operators, exponents, and logarithms. By comparison, a recursive expression refers to a mathematical expression that relies on earlier variables in the sequence to define a current variable.

The derived equation, because it is a closed-form expression, is executed one time before the text is placed on a page. Then, once the appropriate line spacing has been calculated, the columns may be placed on a page. Comparatively a recursive expression would iteratively check and re-adjust the line spacing of the paragraphs until the columns are an appropriate height. By using a closed-form mathematical expression to calculate the line spacing the method may provide a simple way to ensure that the columns of a page are substantially the same height. A closed-form calculation also reduces the time and cost associated with achieving a balanced column layout as it is evaluated one time as opposed to iterative evaluations.

According to an example, the method (300) may also include adjusting (block 310) the paragraphs such that the line spacing of the paragraphs of a particular column are substantially the same. For example, in the mathematical expression described above, the individual paragraphs may be adjusted by different amounts such that the adjusted line spacing, l′, of each paragraph within a particular column is substantially the same.

In an example, at least one paragraph extends over multiple columns. In this example, the method (300) may also include adjusting (block 312) any paragraph that extends over multiple columns such that the line spacing within the paragraph is substantially the same.

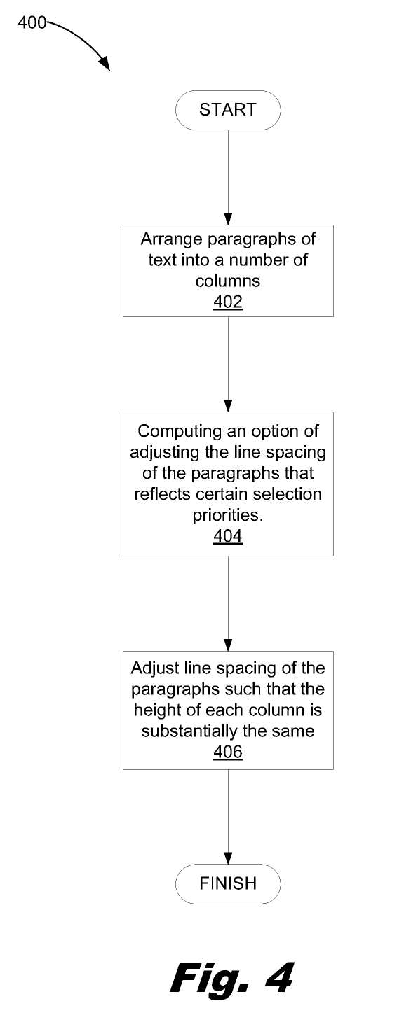

FIG. 4 is a flowchart showing a method (400) for arranging text in columns. The method (400) may begin by arranging (block 402) paragraphs of text into a number of columns. As described above, organizing text into columns may help with the readability and visual aesthetics of the page.

The method (400) may then include computing (block 404) an option of adjusting the line spacing of the paragraphs that reflect certain adjustment priorities. For a given layout, there may be various ways of adjusting the line spacing of the paragraphs such that the heights of the columns are substantially the same.

According to an example, column balance may take priority over preservation of the original line spacing, thus the computed option may be that which primarily balances the columns while secondarily preserving the original line spacing. By comparison, in a different application, preservation of the original line spacing may take priority over column balance. In this application, an option may be computed that primarily preserves the original line spacing while secondarily balances the columns. In these examples, the priorities may be user-defined or defined by the layout of the page.

According to an example, the options may be computed using a mathematical expression. This expression may represent a system of equations that when solved, are used to determine the option that reflects the priorities of the application. In an example, the selected option is that which maximizes the preservation of the original line spacing of the paragraphs of a particular column, such that the columns are properly aligned to substantially the same height, and according to one example, substantially the same height as the column residual height.

An example of a mathematical expression used to evaluate and select the number of options to adjust the line spacing of the paragraphs in a column such that the height of the columns are substantially the same may be illustrated as follows:

$$l = {{Σ}_{t} ( {Σ}_{p} {n}_{p}^{t} {l}_{p}^{f} - {h}_{l} )}^{2} + λ {{Σ}_{p} ( {l}_{p}^{′} - {l}_{p} )}^{2} \qquad ( Eq . 2 )$$

In the above expression (Eq. 2), the letter p is an index that represents the p^{th} paragraph of a page. The letter i is an index that represents the i^{th} column of a page. The letter n represents the number of lines in a given paragraph. Thus, the term nⁱₚ refers to the number of lines in the p^{th} paragraph, in the i^{th} column. The term hᵢ refers to the column residual height. The term lₚ refers to original line spacing of paragraph p. The term l′ₚ, refers to the adjusted line spacing of paragraph p such that the height of the columns may be substantially the same. The symbol λ refers to a parameter that controls the tradeoff between preservation of the original line spacing and column balance. For example, a high λ favors a preservation of the original line spacing of paragraph p. In this example, if there is more than one option that balances the columns, the option with the smaller deviation from the original line spacing will be selected. A low λ favors column balancing. In this example if there is more than one option that balances the columns, the option with the more balanced columns will be selected.

Given this system of equations (Eq. 2), the term J represents the option which strikes the appropriate balance between preservation of the original line spacing and the column balance as defined by the selected λ. Solving the system of equations for all paragraphs will determine the line spacing that will allow the particular columns of a page to be substantially the same height, while minimizing the alteration of the line spacing of the paragraphs of a page.

This expression may derive a closed-form expression from which the line spacing of the paragraphs may be determined. An example of a closed form solution that may derive from the above expression is illustrated as follows:

l′={(N^{T}N)⁻¹N^{T}}^{b} (Eq. 3)

In the above expression (Eq. 3) l′ may be a column matrix of the form:

$${l}^{′} = [ \begin{matrix}{l}_{p}^{F} \\ ⋮ \\ {l}_{p}^{′}\end{matrix} ] \qquad ( Eq . 4 )$$

which reflects the adjusted line spacing of each paragraph p of a page P. In the closed form solution (Eq. 3), N may be a matrix of the form:

$$N ( ϕ , q ) = \{ \begin{matrix}{\sum }_{l = 1}^{l} {n}_{p}^{t} {n}_{q}^{t} p \neq q \\ {\sum }_{l = 1}^{l} {n}_{p}^{t} {n}_{q}^{t} + λ p = q\end{matrix} \qquad ( Eq . 5 )$$

in which l represents the number of columns on a page and i is an index that references the i^{th} column of a page. The terms p and q are indexes that represent paragraphs of a page.

Again, in the closed form expression, b may be an equation of the form:

$$b ( ϕ ) = {\sum }_{l = 1}^{l} {h}_{l} {n}_{p}^{t} + λ {l}_{p} . \qquad ( Eq . 6 )$$

As described above (Eq. 6), using a closed-form expression in this form allows a simple determination of the appropriate line spacing in a single cycle before the text is positioned on a page. Thus, a closed-form solution represents a simple, cost efficient way to balance preservation of line spacing and columnar balance.

The method (400) may then include adjusting (block 406) the line spacing of the paragraphs of the text such that the vertical heights of each column of text is substantially the same. Adjusting the columns to be substantially the same height improves the consistency of the textual layout, visual aesthetics of the page, and increases reader comprehension.

By adjusting the paragraphs of the column of text, the method (400) may also be used with a block-based text rendering system which may not allow for line-by-line alteration of a text's line spacing. The current method (400) does not alter text line-by-line and therefore is compliant with a block-based text rendering system. Therefore, the method offers a simple way to adjust column height when used in conjunction with block-based text rendering systems.

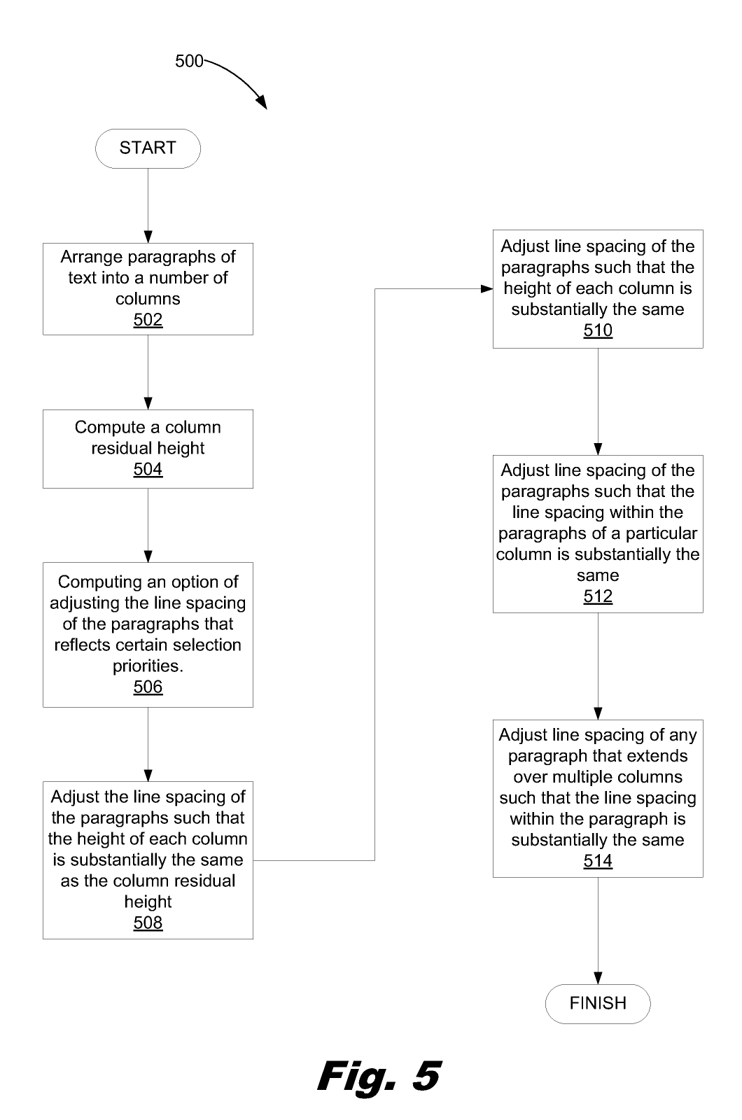

FIG. 5 is a flowchart showing a method (500) for arranging text in columns. The method (500) may begin by arranging (block 502) paragraphs of text into a number of columns. The method (500) may then compute (block 504) a column residual height. This column residual height is a standard to which the columns on the page may be adjusted to substantially match. With a column residual height set, the method (500) may then compute (block 506) an option of adjusting the line spacing of the paragraphs that reflects certain adjustment priorities The computed option reflects the desired balance between preservation of the original line spacing and the balance of the columns. With the option selected the individual columns may then be adjusted (block 508) such that the height of each column is substantially the same as the column residual height.

Next, the height of the columns of a page may be adjusted (block 510) such that the columns are substantially the same as one another. According to an example, the line spacing of the paragraphs in a particular column may then be adjusted (block 512) such that the line spacing of the paragraphs of that column are substantially the same. In this example the line spacing of a particular column would be substantially the same throughout the particular column. According to the above described expression (Eq. 1), the l′ of each paragraph of the column would be the same.

If at least one paragraph extends over multiple columns, the method (500) may also adjust (block 514) the line spacing of any paragraph that extends over multiple columns such that the line spacing within the paragraph is substantially the same.

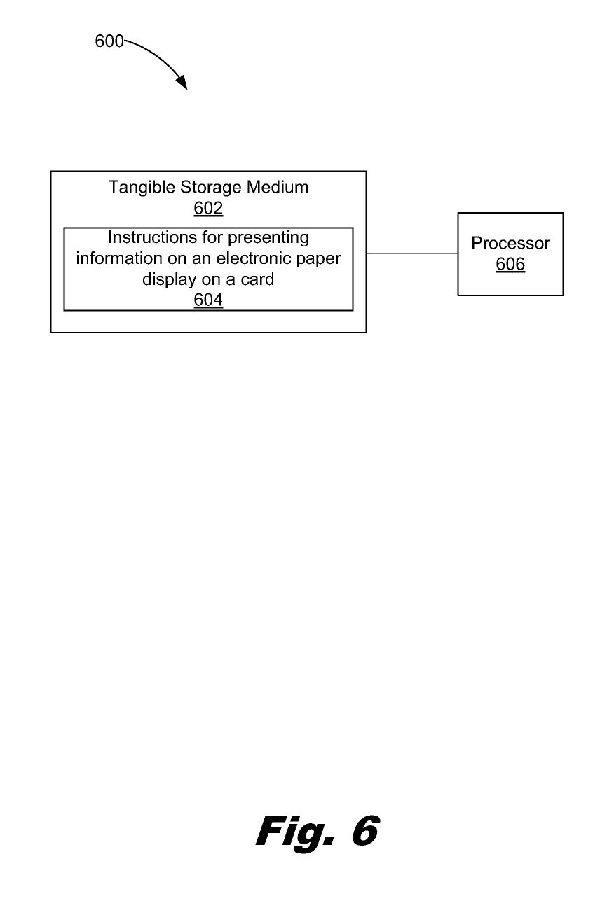

FIG. 6 is a diagram of a computer program product (600) for arranging text into columns. According to an example, the computer program product (600) may include a tangible storage medium (602). The tangible storage medium (602) may include instructions (604) for arranging text into columns. The computer program product (600) may be capable of transferring to a processor (606) the instructions (604) stored on the tangible storage medium (602). The processor (606) may then execute the prescribed functions according to the computer usable code stored on the tangible storage medium (602).

According to an example, the instructions (604) as executed by the processor (606) may direct the processor to arrange text into a number of columns on a page and to adjust the line spacing of the paragraphs such that the height of each column is substantially the same.

The instructions (604) as executed by the processor (606) may direct the processor to compute an option of adjusting the line spacing of the paragraphs of a column. The computed option may be that which minimizes the difference between the adjusted line spacing and the original line spacing.

According to an example, the instructions (604) may also direct the processor (606) to compute a column residual height and adjust the line spacing of the columns such that the columns are substantially the same height as the column residual height.

The preceding description has presented techniques for arranging paragraphs of text into columns. A method includes arranging paragraphs of text into a number of columns and adjusting the line spacing of the paragraphs such that the height of each column is substantially the same. Also disclosed is a method for arranging text into columns of a page including arranging paragraphs of text into a number of columns, evaluating a number of options of adjusting the line spacing of the paragraphs such that the height of each column is substantially the same, selecting one of the options of adjusting the line spacing of the paragraphs, and adjusting the line spacing of the paragraphs according to the selected option.

The techniques presented in the present disclosure offer a simple efficient way to balance columns of text. By using a closed-form solution, no iterations are done to calculate the balanced height, rather a one-time calculation is done to determine a line spacing that will allow the columns to be substantially the same height. The techniques presented can be used with a block-based text rendering system where alteration of line spacing occurs at the paragraph level. According to one example, the specification presents a method that selects amongst a number of options, one which minimizes the alteration of line spacing while balancing columns. In this example, a user may set a priority level between preservation of line spacing and column balance and the method may select an option that coincides with that priority level. Thus a visually pleasing, easy to read columnar arrangement of text is produced in a simple, cost-effective, and timely manner.

The preceding description has been presented to illustrate and describe examples of the principles described. This description is not intended to be exhaustive or to limit these principles to any precise form disclosed. Many modifications and variations are possible in light of the above disclosure.

What is claimed is:

1. A method of arranging text into columns on a page, the text being arranged in paragraphs, the method comprising:
arranging paragraphs of text into a number of columns, the paragraphs comprising a number of lines having a line spacing; and
adjusting the line spacing of the paragraphs such that the height of each column is substantially the same.

2. The method of claim 1, further comprising:
computing a column residual height; and
adjusting the line spacing of the paragraphs such that the height of each column is substantially the same as the column residual height.

3. The method of claim 2, in which the line spacing of the paragraphs is adjusted using a mathematical expression.

4. The method of claim 3, in which the expression for adjusting the line spacing of a column is of the form
$${Σ}_{p} {n}_{p}^{t} {l}_{p}^{′} \approx {h}_{l} ∀ l ,$$
in which;
p is an index that represents the p^{th} paragraph of a page;
i is an index that represents the i^{th} column of the page;
nₚⁱ represents a number of lines in paragraph p of column i;
l′ₚ represents an adjusted line spacing for paragraph p; and
hᵢ represents the column residual height.

5. The method of claim 1, further comprising adjusting the paragraphs such that the line spacing within the paragraphs of a particular column are substantially the same.

6. The method of claim 1, in which at least one paragraph extends over multiple columns.

7. The method of claim 6, further comprising adjusting any paragraph that extends over multiple columns such that the line spacing within the paragraph is substantially the same.

8. A method of arranging text into columns of a page, the text being arranged in paragraphs, the method comprising:
arranging paragraphs of text into a number of columns, the paragraphs comprising a number of lines having a line spacing;
computing an option of adjusting the line spacing of the paragraphs;
and
adjusting the line spacing of the paragraphs according to the computed option.

9. The method of claim 8, further comprising:
computing a column residual height; and
adjusting the line spacing of the paragraphs such that the height of each column is substantially the same as the column residual height.

10. The method of claim 8, in which the computed option reflects a determined balance between preservation of the original line spacing of the paragraphs and column balance.

11. The method of claim 10, in which the option is computed using a mathematical expression.

12. The method of claim 11, in which the expression for evaluating the number of options is in the form
$$l = {{Σ}_{t} ( {Σ}_{p} {n}_{p}^{t} {l}_{p}^{f} - {h}_{l} )}^{2} + λ {{Σ}_{p} ( {l}_{p}^{′} - {l}_{p} )}^{2}$$
in which;
J represents the option that minimizes the adjustment of the line spacing of the paragraphs;
p is an index that represents the p^{th} paragraph of a page;
i is an index that represents the i^{th} column of the page;
nₚⁱ represents a number of lines in paragraph p of column i;
l′ₚ represents an adjusted line spacing for paragraph p;
lₚ represents the original line spacing of paragraph p; and
hᵢ represents the column residual height.

13. A computer program product that includes a tangible storage medium readable by a processor, the medium having stored thereon instructions for arranging text into columns, the instructions comprising:
a set of instructions that, when executed by a processor, causes the processor to arrange text into a number of columns on a page; and
a set of instructions, that when executed by a processor, causes the processor to adjust the line spacing of the paragraphs such that the height of each column is substantially the same.

14. The system of claim 13, wherein the set of instruction further includes:
a set of instructions, that when executed by a processor, computes an option of adjusting the line spacing of the paragraphs that reflects certain adjustment priorities; and
a set of instructions that, when executed by a processor, adjusts the line spacing of the paragraphs according to the computed option.

15. The system of claim 13, wherein the set of instructions further includes;
a set of instructions, that when executed by a processor, computes a column residual height;
a set of instructions, that when executed by a processor, adjusts the line spacing of the paragraphs such that the height of each column is substantially the same as the column residual height;
a set of instructions, that when executed by a processor, adjusts the paragraphs such that the line spacing within the paragraphs is substantially the same; and
a set of instructions, that when executed by a processor, minimizes the adjustment of the line spacing of the paragraphs.
